(19) United States
(12) Patent Application Publication
(10) Pub. No.: US 2022/0147292 A1
(43) Pub. Date: May 12, 2022

(54) PERFORM SECURITY JOBS USING AUTHENTICATION IN IMAGE FORMING APPARATUS

(71) Applicant: HEWLETT-PACKARD DEVELOPMENT COMPANY, L.P., Spring, TX (US)

(72) Inventor: Nam HEO, Pangyo (KR)

(73) Assignee: HEWLETT-PACKARD DEVELOPMENT COMPANY, L.P., Spring, TX (US)

(21) Appl. No.: 17/602,187

(22) PCT Filed: May 12, 2020
(86) PCT No.: PCT/US2020/032483

§ 371 Date: Oct. 7, 2021

(30) Foreign Application Priority Data
Oct. 16, 2019 (KR) 10-2019-0128109

(51) Int. Cl. G06F 3/12; G06F 21/31; G06F 21/60; G06F 21/44

(52) U.S. Cl. CPC G06F 3/1238; G06F 3/1222; G06F 3/1274; G06F 21/44; G06F 21/31; G06F 21/608; G06F 3/1253

(57) ABSTRACT

The present disclosure provides an operation method of an image forming apparatus. The image forming apparatus is to receiver, from an external device, secure job information indicating a job to be performed on information that includes secure information, account information of a receiver of the secure information, and standard account information registered in common for the a user and the receiver. When receiver authentication is required to perform the job, guiding the receiver through the authentication based on the account information of the receiver, the standard account information, and standard password information for the standard account information, to perform the job when the receiver authentication is completed.

### BACKGROUND

In a commonly used image forming apparatus, a user may log in with his or her account and request a command for a predetermined image forming operation. Furthermore, because information in a specific image generated by the image forming apparatus requires security, only an authenticated user is allowed to use the image forming apparatus. In addition, the image forming apparatus may set a use permission range therein for each user. The user is able to use the image forming apparatus within the set use permission range.

### BRIEF DESCRIPTION OF DRAWINGS

The present disclosure will become more readily appreciated from the following description of examples, taken in conjunction with the accompanying drawings in which reference numerals denote structural elements.

FIG. 1 is a conceptual diagram for explaining an operation, performed by an image forming apparatus, of performing a job according to secure job information via receiver authentication, according to an example.

FIG. 2 is a flowchart of a method of operating an external device for transmitting job information to an image forming apparatus, according to an example.

FIG. 3 is a diagram for explaining a screen, displayed on an external device, for setting information related to secure job information, according to an example.

FIG. 4 is a flowchart of an operation method of an image forming apparatus in which a job is performed according to secure job information via receiver authentication, according to an example.

FIG. 5 is a diagram for explaining a process, performed by an image forming apparatus, of guiding receiver authentication, according to an example.

FIG. 6 is a diagram for explaining a screen for setting permission for secure job information, which is displayed on an external device, and a receiver authentication screen displayed on an image forming apparatus, according to an example.

FIG. 7 is a flowchart of an operation method of an image forming apparatus in which authentication of a replacement receiver is performed, according to an example.

FIG. 8 is a flowchart of an operation method of an image forming apparatus in which secure job information is deleted by an administrator of the image forming apparatus, according to an example.

FIG. 9 is a diagram for explaining a secure job list displayed in an image forming apparatus, according to an example.

FIG. 10 is a block diagram of a configuration of an image forming apparatus according to an example.

### DETAILED DESCRIPTION OF EXAMPLES

Throughout the specification, an “image forming apparatus” may denote any apparatus capable of performing an image formation operation, such as a printer, a scanner, a fax machine, a multi-function printer (MFP), or a display device. A “job performed by an image forming apparatus” may be a job related to printing, scanning, faxing, storing, transmitting, etc.

Examples of the disclosure will be described more fully hereinafter with reference to the accompanying drawings so that they may be easily implemented by one of ordinary skill in the art. However, the present disclosure may be implemented in various different forms and is not limited to the examples set forth herein.

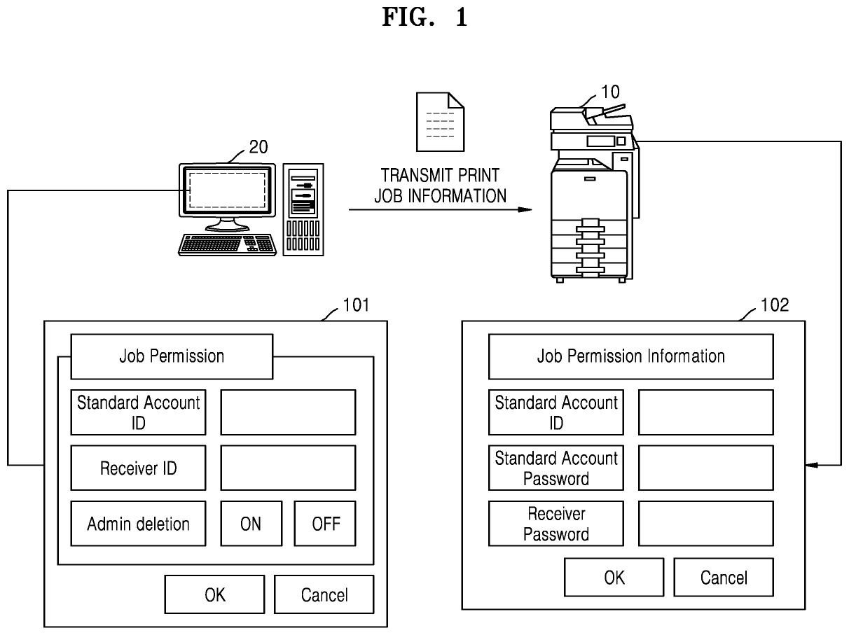

FIG. 1 is a conceptual diagram for explaining an operation, performed by an image forming apparatus, of performing a job according to secure job information via receiver authentication, according to an example.

A first user may request, via an external device 20, a print job for a predetermined document from an image forming apparatus 10. When the predetermined document is a document requiring security, the first user may set permission to allow only a receiver selected by the first user to perform the print job for the predetermined document. For example, the external device 20 may display a screen 101 for setting a job permission. The external device 20 may receive, via the screen 101, an ID of a receiver who will receive the predetermined document and an ID of a standard account registered in common for the first user and the receiver. The external device 20 may set the print job for the predetermined document to be performed by the image forming apparatus 10 via receiver authentication. The external device 20 may transmit print job information regarding the predetermined document to the image forming apparatus 10.

After receiving the print job information, the image forming apparatus 10 may display a print job list. When the receiver who will receive the predetermined document selects print job information from the print job list, the image forming apparatus 10 may perform receiver authentication for the print job. The image forming apparatus 10 may display a screen 102 for receiving information necessary for the receiver authentication. For example, the image forming apparatus 10 may receive, via the screen 102, a standard account ID, a standard account password, and a receiver account ID. When the receiver authentication is completed, the image forming apparatus 10 may perform the print job for the predetermined document.

Furthermore, the external device 20 may receive, via the screen 101, administrator's deletion permission information regarding the print job for the predetermined document. A deletion permission is set for the administrator, and when administrator authentication is completed by the image forming apparatus 10, the image forming apparatus 10 may delete print job information stored therein.

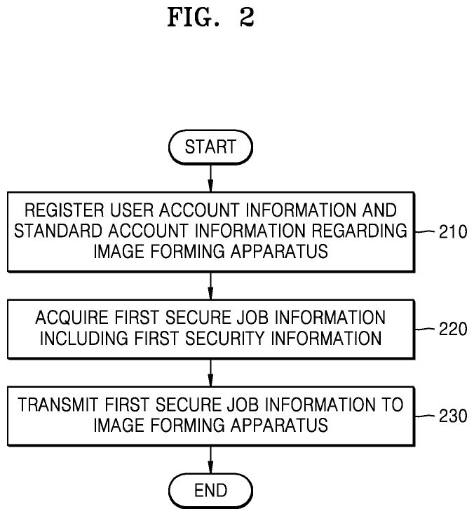

FIG. 2 is a flowchart of a method of operating the external device 20 for transmitting secure job information to the image forming apparatus 10, according to an example.

In operation 210 of the external device 20, the external device 20 may register user account information and standard account information regarding the image forming apparatus 10.

For example, the external device 20 may acquire, based on a user input, user account information including a user name, a user account ID, a user account password, etc. Account information of a specific user may be information necessary for authenticating the specific user so that the specific user can use the image forming apparatus 10. The external device 20 may request registration of the user account information from the image forming apparatus 10 or a server for managing the image forming apparatus 10. The image forming apparatus 10 or the server for managing the image forming apparatus 10 may register the user account information.

For example, the external device 20 may request, based on a user input, registration of standard account information of a group to which the user belongs from the image forming apparatus 10 or the server. The image forming apparatus 10 or the server may register the standard account information of the group to which the user belongs. In this case, the standard account information may be information used to perform user authentication among users in the group. For example, when a first user in the group uses a standard account ID to request a second user in the group for predetermined job information on the image forming apparatus 10, the second user may input a group's standard account ID and a standard account password to the image forming apparatus 10 such that the predetermined job may be performed according to the predetermined job information.

In operation 220 of the external device 20, the external device 20 may acquire first secure job information including first security information that may require security.

For example, the first user may request output of a predetermined document including the first security information at a place where the first user is not present. In this case, since the predetermined document includes the first security information, the predetermined document needs to be output by a user having permission to view the predetermined document that includes the first security information that may require security.

Thus, the external device 20 may set, based on a first user's input, the first secure job information so that the predetermined document including the first security information may be output via receiver authentication of a specific receiver. For example, the first secure job information may include a name of a first secure job, information of a user who requests the first secure job, a type of the first secure job, security information included in the first secure job, information about the time when the first secure job is requested, permission information of a receiver or administrator, which is necessary for executing the first secure job, etc.

For example, the external device 20 may acquire, based on the first user's input, the first secure job information including receiver account information specifying a receiver who will receive the first security information as secure information that may require security and standard account information of a group to which the first user and the receiver belong. In other words, the first user may input information of the receiver such that the first secure job may be performed by the image forming apparatus 10 via the receiver authentication.

In operation 230 of the external device 20, the external device 20 may transmit the first secure job information to the image forming apparatus 10.

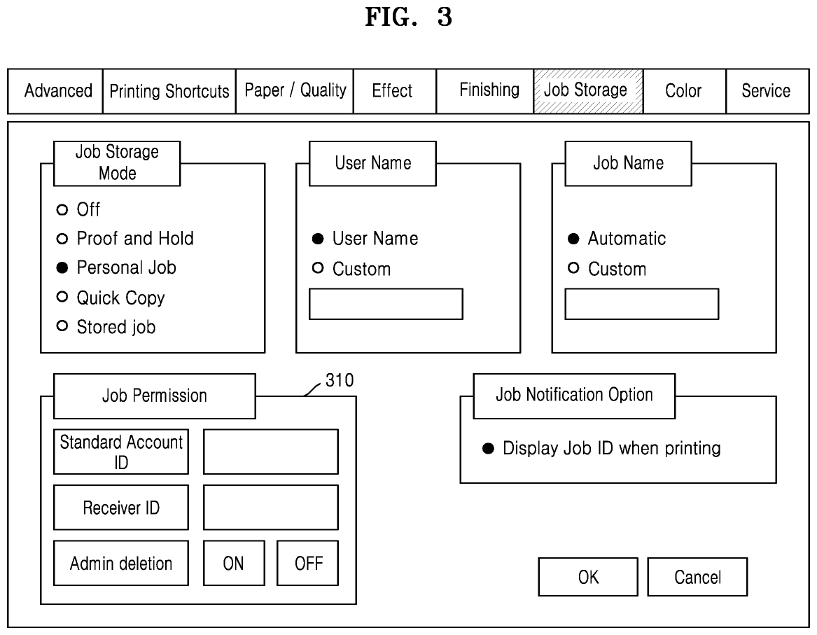

FIG. 3 is a diagram for explaining a screen, displayed on the external device 20, for setting information related to secure job information, according to an example.

Referring to FIG. 3, before the secure job information is transmitted from the external device 20 to the image forming apparatus 10, the external device 20 may receive information for setting a job permission via a job permission setting window 310. For example, the external device 20 may receive information for setting a user having permission to execute or stop a job. For example, the external device 20 may receive an ID of a receiver who will receive information that may require security or secure information, an ID of a standard account for a group to which the user and the receiver belong, and administrator's deletion permission information regarding secure job information.

For example, when the external device 20 receives a receiver ID and a standard account ID via the job permission setting window 310, the external device 20 may set a job, which corresponds to the secure job information, to be performed by the image forming apparatus 10 via receiver authentication.

For example, when the external device 20 receives an administrator's deletion permission as “ON” via the job permission setting window 310, the external device 20 may set the job permission such that the secure job information may be deleted from the image forming apparatus 10 via administrator authentication. Otherwise, when the external device 20 receives the administrator's deletion permission as “OFF” via the job permission setting window 310, the secure job information may not be deleted even if administrator authentication is performed by the image forming apparatus 10.

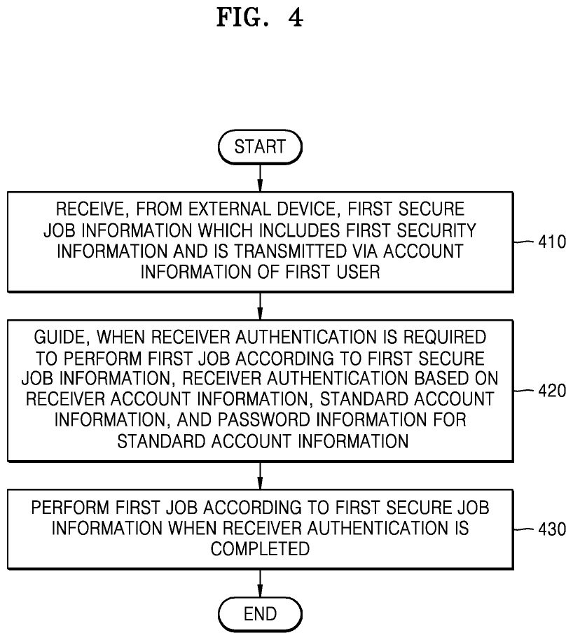

FIG. 4 is a flowchart of an operation method of the image forming apparatus 10 in which a job is performed according to secure job information via receiver authentication, according to an example.

In operation 410 of the image forming apparatus 10, the image forming apparatus 10 may receive, from the external device 20, first secure job information indicating a job to be performed with respect to information, such as a document, including first security information as secure information that may require security or may be required to be secure, which is transmitted from the external device via a job permission setting corresponding to account information of a first user to cause the image forming apparatus authenticate the receiver to perform the first job.

For example, the first secure job information may include account information of a receiver who will receive the first security information, and standard account information registered in common for the first user and the receiver. Furthermore, the first secure job information may include at least one of a name of a first secure job, information of a user who requests the first secure job, type information of the first secure job, security information included in the first secure job, information about the time when the first secure job is requested, and permission information of a receiver or administrator, which is necessary for executing the first secure job.

In operation 420 of the image forming apparatus 10, when receiver authentication is required to perform a first job according to the first secure job information, the image forming apparatus 10 may guide the receiver authentication based on account information of a receiver, standard account information, and password information for the standard account information.

For example, the receiver authentication may be required when the first secure job information includes the account information of the receiver who will receive the first security information and the standard account information, or when the first job corresponding to the first secure job information is set to be performed via the receiver authentication.

For example, the image forming apparatus 10 may determine whether the receiver authentication is required to perform the first job according to the first secure job information, based on a result of checking whether the first secure job information includes the account information of the receiver who will receive the first security information and the standard account information. Here, the standard account information is information about a standard account registered in common for the first user and the receiver. Authentication on the standard account may facilitate authentication between a user and the receiver and increase the reliability of the authentication.

For example, when the first secure job information includes account information of a receiver, which specifies the receiver, and standard account information of a group to which the first user and the receiver belong, the image forming apparatus 10 may determine that the first job corresponding to the first secure job information is set to be performed via the receiver authentication. In this case, the receiver authentication may include authentication on a receiver account and authentication on a standard account.

For example, the image forming apparatus 10 may determine whether the receiver authentication is required, based on a result of checking whether the first job corresponding to the first secure job information is set to be performed via the receiver authentication.

For example, the image forming apparatus 10 may check whether the first secure job information includes account information of a receiver who will receive the first security information and standard account information and whether the first job corresponding to the first secure job information is set to be performed via receiver authentication and guide the receiver authentication based on a result of the checking.

For example, when the receiver authentication is required to perform the first job, the image forming apparatus 10 may guide the receiver authentication based on password information input for the account information of the receiver and the standard account information.

For example, the image forming apparatus 10 may display an authentication screen for receiving authentication information including password information for the account information of the receiver, the standard account information, and standard password information for the standard account information.

In detail, the image forming apparatus 10 may display a job list including a plurality of pieces of job information. The image forming apparatus 10 may generate a job list in such a manner so that predetermined secure job information set such that a specific job is performed via predetermined receiver authentication is distinguishable from predetermined job information for which the predetermined receiver authentication is not required. The image forming apparatus 10 may display the generated job list.

The image forming apparatus 10 may receive an input for selecting the first secure job information from the job list. As an input for selecting the first secure job information is received, the image forming apparatus 10 may display an authentication screen for receiving authentication information regarding the first secure job information. For example, the image forming apparatus 10 may display an authentication screen for receiving at least one of password information for receiver account information, standard account information, and standard password information for the standard account information.

For example, the image forming apparatus 10 may receive the authentication information via the authentication screen. The image forming apparatus 10 may perform the receiver authentication based on a result of checking that the authentication information matches pieces of password information respectively registered with respect to the receiver account information and the standard account information. For example, the image forming apparatus 10 may store, in a memory thereof, pieces of password information respectively registered with respect to the receiver account information and the standard account information, and manage the pieces of password information. For example, when input password information does not match the registered password information, the image forming apparatus 10 may display information indicating that the receiver authentication failed. Otherwise, when the input password information matches the registered password information, the image forming apparatus 10 may display information indicating that the receiver authentication is completed.

In operation 430 of the image forming apparatus 10, when the receiver authentication is completed, the image forming apparatus 10 may perform the first job according to the first secure job information. For example, when the first secure job information indicates a print job for a first document, the image forming apparatus 10 may perform the print job for the first document when the receiver authentication is completed.

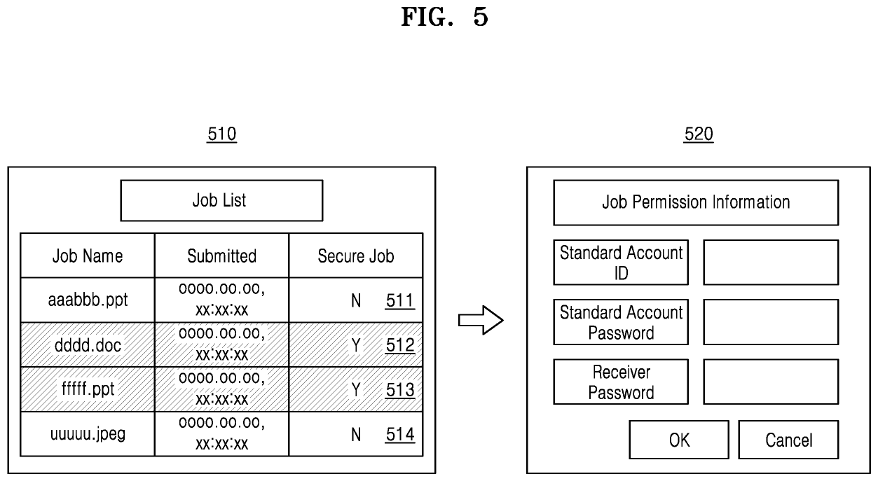

FIG. 5 is a diagram for explaining a process, performed by the image forming apparatus 10, of guiding receiver authentication, according to an example.

Referring to an image 510 of FIG. 5, the image forming apparatus 10 may display a job list including a plurality of pieces of job information. For example, the image forming apparatus 10 may receive an input for selecting a printing option from a menu on the image forming apparatus 10. The image forming apparatus 10 may display a job list including jobs to be printed. The job list may show a job name, the time when a job is requested, and information about whether the job is a secure job. Although not shown in the image 510 of FIG. 5, the job list may also show information of a user who requested a job.

The job list may be displayed such that pieces of secure job information 512 and 513 that require security are distinguished from pieces of general job information 511 and 514 that do not require security. In other words, the image forming apparatus 10 may create the job list in such a manner as to distinguish the pieces of predetermined secure job information 512 and 513, which are set such that specific jobs may be performed via predetermined receiver authentication, from the pieces of predetermined general job information 511 and 514 for which the predetermined receiver authentication is not required. The image forming apparatus 10 may display the created job list.

The image forming apparatus 10 may display the pieces of secure job information 512 and 513 to be distinguished from the pieces of general job information 511 and 514, by using characters, indicators, icons, or shading, each indicating information regarding whether a job in the job list is a secure job.

For example, the image forming apparatus 10 may receive an input for selecting first general job information 511 from the job list. The image forming apparatus 10 may perform a print job for the first general job information.

As another example, the image forming apparatus 10 may select an input for selecting first secure job information 512 from the job list. As shown in an image 520 of FIG. 5, the image forming apparatus 10 may display an authentication screen for receiving authentication information in order to perform receiver authentication for the first secure job information 512. For example, the image forming apparatus 10 may display an authentication screen for receiving a standard account ID, a standard account password, a receiver account ID.

For example, the image forming apparatus 10 may receive, from a receiver, authentication information regarding a standard account ID, a standard account password, a receiver account ID. For example, the image forming apparatus 10 may perform authentication on a receiver account and authentication on a standard account in a sequential, random or simultaneous manner.

For example, the image forming apparatus 10 may perform authentication on the receiver account based on an ID of a receiver account specified by a sender who transmits the first secure job information 512 and a receiver account password input by the receiver. The image forming apparatus 10 may perform authentication on the standard account based on an ID of a standard account specified by the sender who transmits the first secure job information 512 and a standard account ID and a standard account password input by the receiver.

When the authentication on the receiver account and the authentication on the standard account are completed, the image forming apparatus 10 may perform a print job according to the first secure job information. However, when either of the authentication on the receiver account and the authentication on the standard account fails, the image forming apparatus 10 may display a message notifying that the receiver authentication has failed.

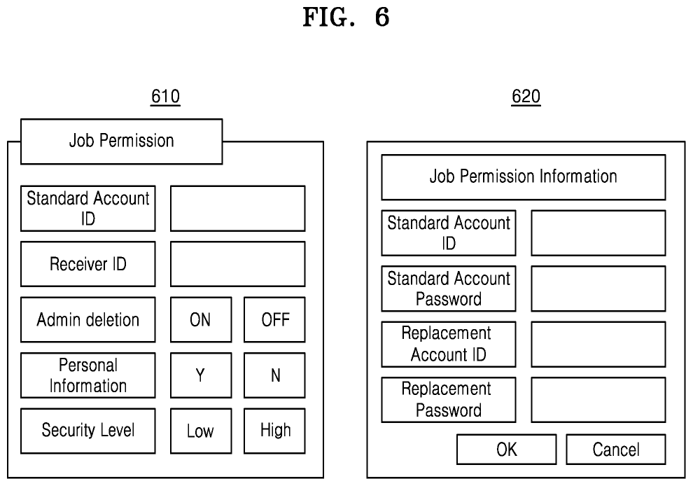

FIG. 6 is a diagram for explaining a screen for setting permission for secure job information, which is displayed on the external device 20, and a receiver authentication screen displayed on the image forming apparatus 10, according to an example.

Referring to an image 610 of FIG. 6, the external device 20 may display a screen for setting a job permission with respect to secure job information. The external device 20 may receive information for setting a job permission. As described with reference to FIG. 3, the external device 20 may receive an ID of a receiver who will receive information that may require security or secure information, an ID of a standard account for a group to which the user and the receiver belong, and an administrator's deletion permission information regarding secure job information.

Furthermore, the external device 20 may receive information indicating whether security information contained in the secure job information is personal information and information indicating a security level of the security information.

For example, when the external device 20 receives “Y” indicating that the security information is personal information, the external device 20 may set a job corresponding to the secure job information to be performed by the image forming apparatus 10 via receiver authentication by the receiver.

For example, the security level may be input as “Low” or “High” according to the degree of importance of security. Although the image 610 of FIG. 6 shows that the security level is classified into two levels, “Low” and “High”, the security level may be classified into three or more levels.

For example, when the external device 20 receives an input for selecting a security level as “Low”, the external device 20 may set a job corresponding to the secure job information to be performed by the image forming apparatus 10 via authentication of a user in a group to which the receiver belongs.

As another example, when the external device 20 receives an input for selecting a security level as “High”, the external device 20 may set a job, corresponding to the secure job information, to be performed by the image forming apparatus 10 via authentication of a user having a security level equal to or higher than a security level set for the receiver.

The image forming apparatus 10 may display an authentication screen for receiving authentication information necessary for performing receiver authentication for the secure job information. However, when the receiver authentication cannot be performed by a receiver specified by the user who transmits the secure job information, the image forming apparatus 10 may perform replacement authentication by a replacement who will replace the receiver. For example, when the security level of security information is low, the replacement may be a user in the group to which the receiver belongs. Furthermore, when the security level of security information is high, the replacement may be a user in the group to which the receiver belongs and having a security level equal to or higher than the security level set for the receiver.

Referring to an image 620 of FIG. 6, the image forming apparatus 10 may display an authentication screen for receiving authentication information to perform replacement authentication for the secure job information. For example, the image forming apparatus 10 may display an authentication screen for receiving a standard account ID, a standard account password, a replacement ID, and a replacement password.

For example, the image forming apparatus 10 may receive, from the replacement, authentication information regarding a standard account ID, a standard account password, a replacement ID, and a replacement password. The image forming apparatus 10 may perform authentication on a replacement account and authentication on the standard account in a sequential, random, or simultaneous manner. Replacement authentication may be performed in the same manner as receiver authentication.

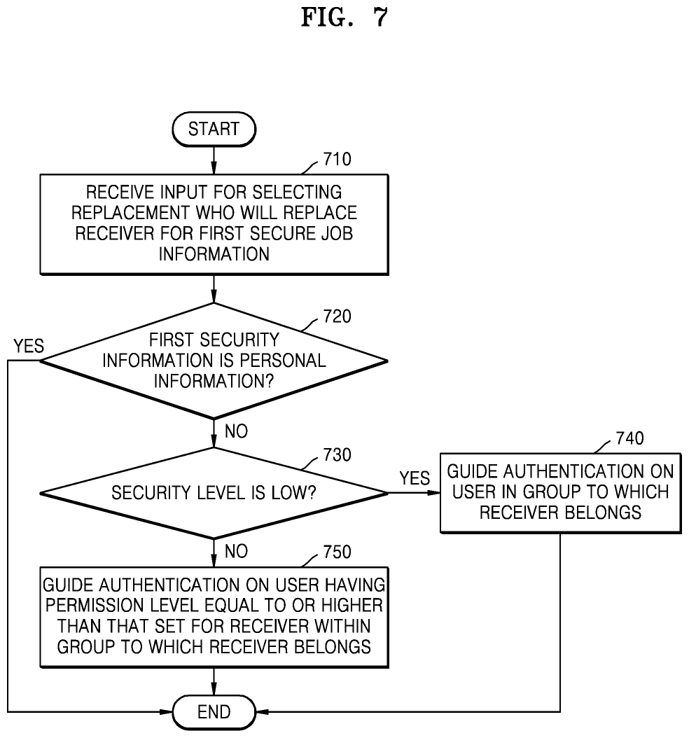

FIG. 7 is a flowchart of an operation method of the image forming apparatus 10 in which authentication of a replacement receiver is performed, according to an example.

In operation 710 of the image forming apparatus 10, the image forming apparatus 10 may receive an input for selecting a replacement who will replace a receiver for first secure job information.

In operation 720 of the image forming apparatus 10, the image forming apparatus 10 may check whether first security information included in the first secure job information is personal information. When the first security information is personal information, the image forming apparatus 10 may not proceed with a process of authenticating the replacement. In other words, because the first security information is personal information, the image forming apparatus 10 may not leak the first security information to a user other than the receiver. Otherwise, when the first security information is not personal information, the image forming apparatus 10 may check whether a security level of the first security information is low according to operation 730.

When the security level of the first security information is low, according to operation 740 of the image forming apparatus 10, the image forming apparatus 10 may guide authentication on the replacement in a group to which the receiver belongs. For example, when the replacement is a user in the group to which the receiver belongs, the image forming apparatus 10 may perform a first job corresponding to the first secure job information via authentication of the user in the group, regardless of a security level set for the user in the group.

When the security level of the first security information is not low, according to operation 750 of the image forming apparatus 10, the image forming apparatus 10 may guide authentication on a replacement having a security level equal to or higher than a security level set for the receiver within the group to which the receiver belongs. In other words, when the security level of the first security information is high, the image forming apparatus 10 may perform the first job according to the first secure job information via authentication of a replacement having a security level equal to or higher than that set for the receiver within the group to which the receiver belongs.

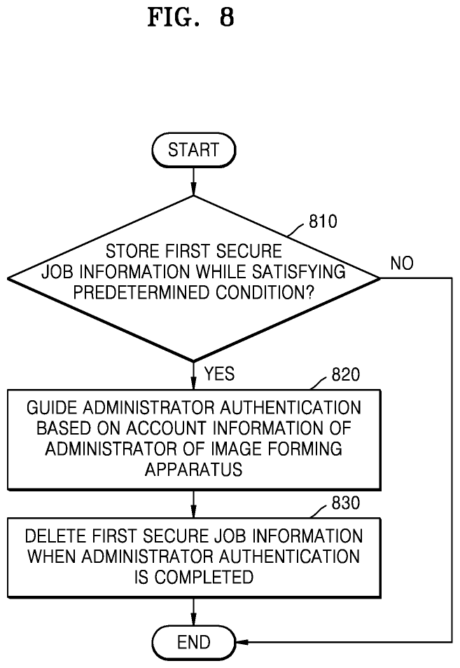

FIG. 8 is a flowchart of an operation method of the image forming apparatus 10 in which secure job information is deleted by an administrator of the image forming apparatus 10, according to an example.

In operation 810 of the image forming apparatus 10, the image forming apparatus 10 may determine whether first secure job information is stored while satisfying a predetermined condition. For example, the predetermined condition may be at least one of a condition in which the first secure job information is continuously stored in the image forming apparatus 10 for a preset period, a condition in which a first user does not log in to the image forming apparatus 10 throughout the preset period, and a condition in which a request for deletion of the first secure job information is received from an administrator of the image forming apparatus 10.

When the first secure job information is stored in the image forming apparatus 10 while satisfying the predetermined condition, according to operation 820, the image forming apparatus 10 may guide administrator authentication based on account information of the administrator of the image forming apparatus 10.

For example, the image forming apparatus 10 may display an authentication screen for receiving authentication information including administrator account information and password information for the administrator account information. The image forming apparatus 10 may receive authentication information via the authentication screen. The image forming apparatus 10 may perform administrator authentication based on a result of checking whether the authentication information matches registered administrator account information and password information registered with respect to the administrator account information.

In operation 830 of the image forming apparatus 10, when the administrator authentication is completed, the image forming apparatus 10 may delete the first secure job information.

The image forming apparatus 10 may display a job list including the first secure job information that is deletable by the administrator. When an input for selecting the first secure job information from the job list is received, the image forming apparatus 10 may delete the first secure job information.

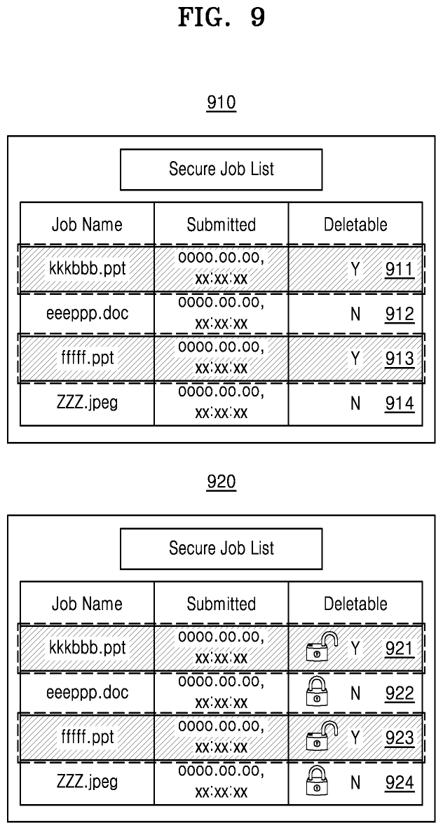

FIG. 9 is a diagram for explaining a secure job list displayed in the image forming apparatus 10, according to an example.

Referring to images 910 and 920 of FIG. 9, the image forming apparatus 10 may display a secure job list including a plurality of pieces of secure job information. The secure job list may show a job name, the time when a job is requested, and information about whether secure job information is deletable.

For example, the secure job list shown in the image 910 may be displayed such that pieces of secure job information 911 and 913 that are deletable by an administrator are distinguished from pieces of secure job information 912 and 914 that are not deletable by the administrator. The image forming apparatus 10 may display information indicating whether secure job information is deletable by the administrator from the secure job list by using a character, an indicator, an icon, or shading.

For example, the image forming apparatus 10 may receive an input for selecting first secure job information 911 from the secure job list. The image forming apparatus 10 may delete the first secure job information stored therein.

For example, referring to a secure job list shown in the image 920 of FIG. 9, pieces of secure job information 921 and 923 that are deletable by the administrator may each be represented by an unlocked lock icon together with an indication that they can be deleted by the administrator, while pieces of secure job information 922 and 924 that are not deletable by the administrator may be each represented by a locked lock icon with an indication that they cannot be deleted by the administrator.

As another example, the pieces of secure job information 921 and 923 that are deletable by the administrator may be each represented by only an unlocked lock icon, while the pieces of secure job information 922 and 924 that are not deletable by the administrator may be each represented by only a locked lock icon.

For example, the image forming apparatus 10 may receive an input for selecting the second secure job information 922 from the secure job list. The image forming apparatus 10 may display a message notifying that the second secure job information 922 is not deletable.

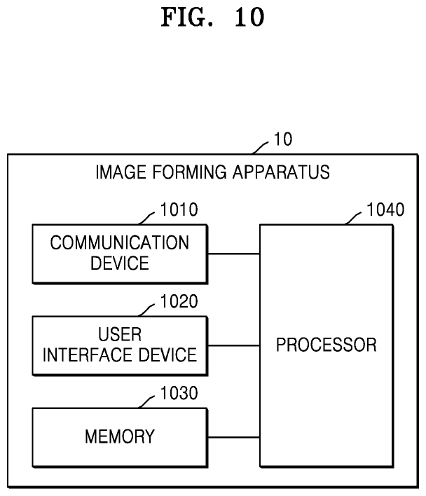

FIG. 10 is a block diagram of a configuration of an image forming apparatus 10 according to an example.

The image forming apparatus 10 of FIG. 10 may include a communication device 1010, a user interface device 1020, a memory 1030, and a processor 1040. However, the components shown in FIG. 10 are not essential components. The image forming apparatus 10 may be implemented with more or fewer components than those shown in FIG. 10. Operations and configurations of the components are now described.

The communication device 1010 may perform communication with an external device. In detail, the communication device 1010 may be connected to a network by wire or wirelessly to communicate with the external device. In this case, the external device may be an external server for managing the image forming apparatus 10 and an electronic device that requests a predetermined job from the image forming apparatus 10. The communication device 1010 may include a communication module for supporting one of various wired and wireless communication methods. For example, the communication module may be a short-range wireless communication module or a wired communication module.

The user interface device 1020 may include an input unit for receiving an input for controlling an operation of the image forming apparatus 10 from a user and an output unit for displaying information such as a result of the operation of the image forming apparatus 10, a state of the image forming apparatus 10, etc. For example, the user interface device 1020 may include an operation panel for receiving a user input, a display panel for displaying a screen, etc.

In detail, the input unit may include, for example, devices capable of receiving various types of user inputs, such as a keyboard, a physical button, a touch screen, a camera, or a microphone. Furthermore, the output unit may include, for example, a display panel or a speaker. However, the user interface device 1020 is not limited thereto and may include a device for supporting various inputs/outputs.

The memory 1030 may store software or programs. The memory 1030 may store at least one program used when the image forming apparatus 10 performs a predetermined job via user authentication. Furthermore, the memory 1030 may store pieces of account information of a plurality of users using the image forming apparatus 10 and pieces of standard account information of the plurality of users. The memory 1030 may map and store IDs and passwords of user accounts for a plurality of users. Furthermore, the memory 1030 may map and store IDs and passwords of standard accounts for each group.

The processor 1040 may execute a program stored in the memory 1030, read data or a file stored in the memory 1030, or store a new file in the memory 1030. The processor 1040 may execute instructions stored in the memory 1030.

The communication device 1010 may receive, from an external device, first secure job information including first security information as secure information that may require security or may be required to be secure, which is transmitted from the external device via a job permission setting corresponding to account information of a first user to cause the image forming apparatus authenticate the receiver to perform the first job.

For example, the first secure job information may include account information of a receiver who will receive the first security information, and standard account information registered in common for the first user and the receiver. Furthermore, the first secure job information may include at least one of a name of a first secure job, information of a user who requests the first secure job, type information of the first secure job, security information included in the first secure job, information about the time when the first secure job is requested, and permission information of a receiver or administrator, which is necessary for executing the first secure job.

When receiver authentication is required to perform a first job according to the first secure job information, the processor 1040 may guide the receiver authentication based on account information of a receiver, standard account information, and password information for the standard account information.

For example, the receiver authentication may be required when the first secure job information includes the account information of the receiver who will receive the first security information and the standard account information, or when the first job corresponding to the first secure job information is set to be performed via the receiver authentication.

For example, the processor 1040 may determine whether the receiver authentication is required to perform the first job corresponding to the first secure job information, based on a result of checking whether the first secure job information includes the account information of the receiver who will receive the first security information and the standard account information. Here, the standard account information is information about a standard account registered in common for the first user and the receiver. Authentication on the standard account may facilitate authentication between a user and the receiver and increase the reliability of the authentication.

For example, when the first secure job information includes account information of a receiver, which specifies the receiver, and standard account information of a group to which the first user and the receiver belong, the processor 1040 may determine that the first job corresponding to the first secure job information is set to be performed via the receiver authentication. In this case, the receiver authentication may include authentication on a receiver account and authentication on a standard account.

For example, the processor 1040 may determine whether the receiver authentication is required, based on a result of checking whether the first job corresponding to the first secure job information is set to be performed via the receiver authentication.

For example, the processor 1040 may check whether the first secure job information includes account information of a receiver who will receive the first security information and standard account information and whether the first job corresponding to the first secure job information is set to be performed via receiver authentication and guide the receiver authentication based on a result of the checking.

For example, when the receiver authentication is required to perform the first job, the processor 1040 may guide, via the user interface device 1020, the receiver authentication based on password information input for the account information of the receiver and the standard account information.

For example, the user interface device 1020 may display an authentication screen for receiving authentication information including password information for the account information of the receiver, the standard account information, and standard password information for the standard account information.

In detail, the user interface device 1020 may display a job list including a plurality of pieces of job information. The processor 1040 may generate a job list in such a manner as to distinguish predetermined secure job information set such that a specific job is performed via predetermined receiver authentication from predetermined job information for which the predetermined receiver authentication is not required. The user interface device 1020 may display the generated job list.

The user interface device 1020 may receive an input for selecting the first secure job information from the job list. As an input for selecting the first secure job information is received, the processor 1040 may display, via the user interface device 1020, an authentication screen for receiving authentication information regarding the first secure job information. For example, the user interface device 1020 may display an authentication screen for receiving at least one of password information for receiver account information, standard account information, and standard password information for the standard account information.

For example, the processor 1040 may receive the authentication information via the authentication screen displayed on the user interface device 1020. The processor 1040 may perform the receiver authentication based on a result of checking that the authentication information matches pieces of password information respectively registered with respect to the receiver account information and the standard account information. Meanwhile, the memory 1030 may store and manage the pieces of password information respectively registered with respect to the receiver account information and the standard account information. The processor 1040 may check whether input password information matches the registered password information. When the input password information does not match the registered password information, the processor 1040 may display information indicating that the receiver authentication failed via the user interface device 1020. Otherwise, when the input password information matches the registered password information, the processor 1040 may control information indicating that the receiver authentication is completed to be displayed via the user interface device 1020.

When the receiver authentication is completed, the processor 1040 may control the components of the image forming apparatus 10 such that the first job is performed according to the first secure job information. When the first secure job information indicates a print job for a first document, the processor 1040 may perform the print job for the first document when the receiver authentication is completed.

In addition, when there is no receiver who can execute the first job according to the first secure job information, the processor 1040 may guide the first job such that the first job may be performed via authentication of a replacement who will replace a receiver.

For example, the user interface device 1020 may receive an input for selecting a replacement who will replace a receiver for first secure job information.

The processor 1040 may check whether first security information included in the first secure job information is personal information. When the first security information is personal information, the processor 1040 may not proceed with a process of authenticating the replacement. In other words, because the first security information is personal information, the image forming apparatus 10 may not leak the first security information to a user other than the receiver. Otherwise, when the first security information is not personal information, the processor 1040 may proceed with the process of authenticating the replacement.

For example, the processor 1040 may check whether a security level of the first security information is low.

For example, when the security level of the first security information is low, the processor 1040 may guide authentication on the replacement in a group to which the receiver belongs. For example, when a user is in the group to which the replacement belongs, the processor 1040 may perform a first job according to the first secure job information via authentication of the user in the group, regardless of a security level set for the user in the group.

For example, when the security level of the first security information is not low, the processor 1040 may guide authentication on a replacement having a security level equal to or higher than a security level set for the receiver within the group to which the receiver belongs. In other words, when the security level of the first security information is high, the processor 1040 may perform the first job according to the first secure job information via authentication of a replacement having a security level equal to or higher than that set for the receiver within the group to which the receiver belongs.

The processor 1040 may determine whether first secure job information is stored in the memory 1030 while satisfying a predetermined condition. For example, the predetermined condition may be at least one of a condition in which the first secure job information is continuously stored in the image forming apparatus 10 for a preset period, a condition in which a first user continuously performs no login to the image forming apparatus for the preset period, and a condition in which a request for deletion of the first secure job information is received from an administrator of the image forming apparatus 10.

When the first secure job information is stored in the memory 1030 while satisfying the predetermined condition, the processor 1040 may guide administrator authentication based on account information of the administrator of the image forming apparatus 10.

For example, the user interface device 1020 may display an authentication screen for receiving authentication information including administrator account information and password information for the administrator account information. The processor 1040 may receive authentication information via the authentication screen. The processor 1040 may perform administrator authentication based on a result of checking whether the authentication information matches registered administrator account information and password information registered with respect to the administrator account information.

When the administrator authentication is completed, the processor 1040 may delete the first secure job information stored in the memory 1030.

The user interface device 1020 may display a job list including the first secure job information that is deletable by the administrator. When an input for selecting the first secure job information from the job list is received, the image forming apparatus 10 may delete the first secure job information.

The operation methods of the image forming apparatus 10 and the external device 20 may be implemented in the form of computer-readable storage media having stored therein instructions or data that can be executed by a computer or processor. The operation methods can be recorded in programs that can be executed on a computer and be implemented through general-purpose digital computers which can run the programs using computer-readable storage media. Examples of the computer-readable storage media may include read-only memory (ROM), random-access memory (RAM), flash memory, compact disk (CD)-ROMs, CD-recordables (CD-Rs), CD-rewritables (CD-RWs), CD+RWs, digital video disk-ROMs (DVD-ROMs), DVD-Rs, DVD+Rs, DVD-RWs, DVD+RWs, DVD-RAMs, Blu-ray disk-ROMs (BD-ROMs), BD-Rs, BD-R low to high (BD-R LTHs), BD-rewritables (BD-REs), magnetic tapes, floppy disks, magneto-optical data storage devices, optical data storage devices, hard disks, solid-state disks (SSDs), and any device capable of storing instructions or software, associated data, data files, and data structures and providing the instructions or software, the associated data, the data files, and the data structures to a processor or computer such that the processor or computer may execute the instructions.

It should be understood that examples described herein should be considered in a descriptive sense only and not for purposes of limitation. Descriptions of features or aspects within each example should typically be considered as available for other similar features or aspects in other examples. While one or more examples have been described with reference to the figures, it will be understood by those of ordinary skill in the art that various changes in form and details may be made therein without departing from the spirit and scope as defined by the following claims.

What is claimed is:

1. An operation method of an image forming apparatus, the method comprising:
receiving, from an external device, secure job information indicating a job to be performed with respect to information that includes secure information, account information of a receiver of the secure information, and standard account information registered in common for a user and the receiver; and
when an authentication of the receiver is required according to the secure job information to perform the job, guiding the receiver through the authentication based on the account information of the receiver, the standard account information, and standard password information for the standard account information, to perform the job when the authentication of the receiver is completed.

2. The operation method of claim 1, wherein,
the standard account information is for a group to which the user and the receiver belong, and
the authentication of the receiver is required when the secure job information includes the account information of the receiver, information specifying the receiver, and the standard account information, and when the job is set in the job permission setting to be performed via the authentication of the receiver.

3. The operation method of claim 1, wherein the guiding of the receiver to authenticate the receiver comprises:
displaying an authentication screen to receive authentication information including receiver password information for the account information of the receiver, the standard account information, and standard password information for the standard account information;
receiving the authentication information via the authentication screen; and
performing the authentication of the receiver based on the authentication information matching pieces of registered password information respectively registered with respect to the account information of the receiver and the standard account information.

4. The operation method of claim 3, wherein the displaying of the authentication screen comprises:
displaying a job list including a plurality of pieces of job information;
receiving an input to select the secure job information from the job list; and
displaying an authentication screen to receive at least any one of the password information for the account information of the receiver, the standard account information, or the standard password information for the standard account information.

5. The operation method of claim 4, wherein the displaying of the job list including the plurality of pieces of job information comprises:
generating the job list in a manner to distinguish secure job information, which is set to require a job to be performed via an authentication of a receiver of the job, from other job information for which an authentication of a receiver of the job is not required; and
displaying the generated job list.

6. The operation method of claim 1, further comprising guiding deletion of the secure job information when the secure job information is stored in the image forming apparatus while satisfying a determined condition.

7. The operation method of claim 6, wherein the determined condition comprises any one or combination of conditions including:
a condition in which the secure job information is continuously stored in the image forming apparatus for a set period of time;
a condition in which the user does not log in to the image forming apparatus throughout the set period; and
a condition in which a request for deletion of the secure job information is received from an administrator of the image forming apparatus.

8. The operation method of claim 6, wherein the guiding of deletion of the secure job information comprises:
guiding an authentication of the administrator based on account information of the administrator of the image forming apparatus; and
deleting the secure job information when the authentication of the administrator is completed.

9. The operation method of claim 8, wherein the guiding of the authentication of the administrator comprises:
displaying an authentication screen to receive authentication information including the account information of the administrator of the image forming apparatus and password information for the account information of the administrator;
receiving the authentication information via the authentication screen; and
performing the authentication of the administrator based on checking whether the authentication information matches registered account information of the administrator and registered password information registered with respect to the account information of the administrator.

10. The operation method of claim 8, wherein the deleting of the secure job information when the authentication of the administrator is completed comprises:
displaying a job list including the secure job information that is deletable by the administrator; and
deleting the secure job information when an input for selecting the secure job information from the job list is received.

11. A non-transitory computer-readable storage medium having stored therein instructions executable by a processor to control an image forming apparatus to:
receive, from an external device, secure job information indicating a job to be performed with respect to information that includes secure information, account information of a receiver of the secure information, and standard account information registered in common for a user and the receiver;
guide, when an authentication of the receiver is required according to the secure job information to perform the job, the receiver through the authentication of the receiver based on the account information of the receiver, the standard account information, and standard password information for the standard account information, to perform the job when the authentication of the receiver is completed.

12. An image forming apparatus comprising:
a communication device to perform communication with an external device;
a user interface device; and
a processor to couple to a memory and control operations to,
receive, from the external device, secure job information indicating a job to be performed with respect to information that includes secure information, account information of a receiver of the secure information, and standard account information registered in common for a user and the receiver;
when an authentication of the receiver is required according to the secure job information to perform the job, guide the receiver through the authentication of the receiver based on the account information of the receiver, the standard account information, and standard password information for the standard account information, to perform the job when the authentication of the receiver is completed.

13. The image forming apparatus of claim 12, wherein
the standard account information is for a group to which the user and the receiver belong, and
the processor is to control an operation to guide the receiver through the authentication of the receiver via the user interface device, when the secure job information includes the account information of the receiver, information specifying the receiver, and the standard account information, and when the job is set in the job permission setting to be performed via the authentication of the receiver.

14. The image forming apparatus of claim 12, wherein the processor is to control an operation to:
display, via the user interface device, an authentication screen to receive authentication information including receiver password information for the account information of the receiver, the standard account information, and standard password information for the standard account information, and receive the authentication information via the authentication screen; and
perform the authentication of the receiver based on checking that the authentication information matches pieces of registered password information respectively registered with respect to the account information of the receiver and the standard account information.

15. The image forming apparatus of claim 1, wherein the secure job information is transmitted from the external device via a job permission setting corresponding to account information of the user, to cause the image forming apparatus authenticate the receiver to perform the job.
